(19) United States
(12) Patent Application Publication
(10) Pub. No.: US 2026/0048488 A1
(43) Pub. Date: Feb. 19, 2026

(54) POWER TOOL INCLUDING OUTER ROTOR MOTOR WITH HIGH SWITCHING FREQUENCY

(71) Applicant: MILWAUKEE ELECTRIC TOOL CORPORATION, Brookfield, WI (US)

(72) Inventors: Andrew D. Bendtsen, Oak Creek, WI (US); Joshua A. Navin, Menomonee Falls, WI (US); Benjamin D. Andersen, Menomonee Falls, WI (US); Jacob G. Wood, Waukesha, WI (US); William Z. Weis, Richfield, WI (US); John Michael Q. Van Treeck, Lannon, WI (US)

(21) Appl. No.: 19/298,450

(22) Filed: Aug. 13, 2025

Related U.S. Application Data
(60) Provisional application No. 63/683,090, filed on Aug. 14, 2024.

(51) Int. Cl. B25B 21/00; H02P 27/06

(52) U.S. Cl. CPC B25B 21/004; H02P 27/06

(57) ABSTRACT

Power tools and methods of operating the same. One power tool includes a housing, a battery pack receptacle coupled to the housing and configured to receive a power tool battery pack, and a motor supported within the housing, wherein the motor is configured to be powered by the power tool battery pack. The power tool further includes an inverter electrically connected to the motor, wherein the inverter includes a plurality of switching elements. The power tool further includes a controller including an electronic processor configured to generate a control signal to operate the plurality of switching elements of the inverter at a switching frequency between approximately 20 kHz and approximately 100 kHz to provide power from the power tool battery pack to drive the motor.

### RELATED APPLICATIONS

This application claims priority to U.S. Provisional Patent Application No. 63/683,090, filed Aug. 14, 2024, the entire contents of which is incorporated herein by reference.

### FIELD

The present disclosure relates to power tools, and more particularly to power tool motors, such as, for example, outer rotor motors.

### SUMMARY

Power tools include motors that are typically powered by an electrical source, such as a DC battery or a conventional AC source. Low inductance motors, such as outer rotor motors (e.g., having a low number of turns), can cause current ripple to be high (i.e., high swings in current and heat), which can cause thermal losses (e.g., of capacitors) to become significantly high. Small components included in such power tools, such as handheld power tools, may provide low heat dissipation to provide thermal management. Accordingly, examples described herein address these and other issues by performing an increased transistor switching frequency, which decreases the time available for current to ripple to occur within the system. For example, power tools described herein (e.g., powered ratchet tools) operate at an increased (e.g., increased as compared to 8 kHz used in traditional motors) switching frequency. Using such an increased switching frequency lowers current ripple leading to less thermal losses and, with low inductance motors, improves speed linearity by lessening current saturation due to high current ripple.

In some aspects, the techniques described herein relate to an electric ratchet power tool including a housing, a battery pack receptacle coupled to the housing and configured to receive a power tool battery pack, a motor supported within the housing, the motor configured to be powered by the power tool battery pack, an inverter electrically connected to the motor, the inverter including a plurality of switching elements, and a controller including an electronic processor configured to generate a control signal to operate the plurality of switching elements of the inverter at a switching frequency between approximately 20 kilohertz and approximately 100 kilohertz to provide power from the power tool battery pack to drive the motor.

In some aspects, the techniques described herein relate to a power tool, wherein the motor is an outer rotor motor. In some aspects, the techniques described herein relate to a power tool, wherein the motor has an outer diameter between 20 millimeters and 40 millimeters. In some aspects, the techniques described herein relate to a power tool, wherein the motor has an outer diameter of 28 millimeters. In some aspects, the techniques described herein relate to a power tool, wherein the switching frequency is approximately 60 kilohertz. In some aspects, the techniques described herein relate to a power tool, wherein the switching frequency is approximately 80 kilohertz. In some aspects, the techniques described herein relate to a power tool, wherein the switching frequency is approximately 100 kilohertz.

In some aspects, the techniques described herein relate to a power tool, wherein the controller is configured to generate a control signal to operate the plurality of switching elements of the inverter at a switching frequency of approximately 60 kilohertz, wherein the control signal is generated using synchronous rectification.

In some aspects, the techniques described herein relate to a power tool further including a current sense resistor configured to sense an electrical current of the plurality of switching elements, the current sense resistor having a first reference voltage point, and a plurality of bridge capacitors electrically connected to the plurality of switching elements, the plurality of bridge capacitors having a second reference voltage point, wherein the first reference voltage point is different than the second reference voltage point. In some aspects, the techniques described herein relate to a power tool, wherein the plurality of bridge capacitors includes at least one hybrid polymer capacitor.

In some aspects, the techniques described herein relate to a controller for a handheld power tool, the controller including a memory storing instructions, a processing unit communicatively coupled to the memory and configured to execute the instructions to perform a set of functions, the set of functions including generating a control signal for an inverter included in the handheld power tool, the inverter having a plurality of switching elements, the control signal operating the plurality of switching elements at a switching frequency between approximately 20 kilohertz and approximately 100 kilohertz to drive an outer rotor motor included in the handheld power tool.

In some aspects, the techniques described herein relate to a controller, wherein the controller is configured to generate a control signal to operate the plurality of switching elements of the inverter at a switching frequency of approximately 60 kilohertz, wherein the control signal is generated using synchronous rectification.

In some aspects, the techniques described herein relate to a controller, wherein generating the control signal includes receiving a reference voltage of a current sense resistor, the current sense resistor electrically coupled to the plurality of switching elements, and generating the control signal based on the reference voltage of the current sense resistor, wherein the reference voltage of the current sense resistor is different than a reference voltage of a bridge capacitor electrically connected to the plurality of switching elements.

In some aspects, the techniques described herein relate to a controller, wherein the switching frequency is approximately 60 kilohertz. In some aspects, the techniques described herein relate to a controller, wherein the switching frequency is approximately 80 kilohertz.

In some aspects, the techniques described herein relate to a controller, wherein the switching frequency is approximately 100 kilohertz. In some aspects, the techniques described herein relate to a power tool including a housing, an outer rotor motor supported within the housing, the outer rotor motor having a diameter between approximately 20 millimeters and 40 millimeters, an inverter electrically connected to the motor, the inverter including a plurality of switching elements, and a controller including an electronic processor configured to generate a control signal to operate the plurality of switching elements of the inverter at a switching frequency between approximately 20 kilohertz and approximately 100 kilohertz to drive the outer rotor motor. In some aspects, the techniques described herein relate to a power tool, wherein the outer rotor motor has a diameter between approximately 30 millimeters and 36 millimeters.

In some aspects, the techniques described herein relate to a power tool, wherein the controller is configured to generate a control signal to operate the plurality of switching elements of the inverter at a switching frequency of approximately 60 kilohertz, wherein the control signal is generated using synchronous rectification. In some aspects, the techniques described herein relate to a power tool, wherein the plurality of switching elements include at least one gallium nitride N-channel switch.

### BRIEF DESCRIPTION OF DRAWINGS

FIG. 1A is an illustration of a power tool, according to some aspects.

FIG. 1B is an illustration of a power tool including an outer rotor motor, according to some aspects.

FIG. 2 is an electromechanical illustration of the power tool of FIGS. 1A and 1B, according to some aspects.

FIG. 3 is a circuit diagram of current measurement circuitry of the power tool of FIGS. 1A and 1B, according to some aspects.

FIG. 4 is a graphical illustration of current ripple, according to some aspects.

FIG. 5 is a graph of inverter switching frequencies according to some aspects.

FIG. 6 is a graph of bridge capacitor temperatures at differing switching frequencies, according to some aspects.

### DETAILED DESCRIPTION

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Power tools include motors, such as brushless direct current (BLDC) motors. One type of a BLDC motor is a surface permanent magnet (SPM) motor, which includes a stator, a rotor, and permanent magnets affixed to or embedded in an exterior surface of the rotor. Another type of BLDC motor is an outer rotor motor, which has a rotor that surrounds and rotates about the stator. For example, an outer rotor motor may include a cylindrical permanent magnet rotor that surrounds a fixed internal stator core. The inverted configuration of the outer rotor motor allows for a larger diameter rotor design, which can accommodate more magnetic poles, provide a larger air gap radius, and produce higher torque at lower speeds when compared to other types of BLDC motors. For example, the larger rotor diameter increases the leverage applied by the motor, resulting in improved torque output.

However, some outer rotor motors, such as those used in power tools, experience low inductance. For example, as the rotor surrounds the stator, an outer rotor motor may have a larger diameter rotor with more magnetic poles than a motor with an interior rotor. This configuration results in a shorter active length of the windings in the stator. The shorter windings inherently have a lower inductance. Additionally, any accompanying increased air gap radius in the outer rotor motor design further contributes to reducing the overall inductance of the motor.

The low inductance of the outer motor provides faster current rise times, which may result in quicker changes in motor speed leading to more responsive operator control. Additionally, the low inductance enables higher operating speeds. The low inductance of outer rotor motors, however, also leads to higher ripple currents, which may increase thermal losses and potentially affect the motor's efficiency. To mitigate these effects, examples described herein provide systems and methods that operate an outer rotor motor at higher switching frequencies, which smooths out the current, reduces thermal loss, and improves overall system performance. Accordingly, as used herein, a high switching frequency refers to a frequency between approximately 20 kHz (kilohertz) and approximately 100 kHz or a subrange thereof (e.g., between approximately 20 kHz and approximately 60 kHz, between approximately 25 kHz and approximately 60 kHz, between approximately 30 kHz and approximately 60 kHz, between approximately 35 kHz and approximately 60 kHz, between approximately 40 kHz and approximately 60 kHz, between approximately 45 kHz and approximately 60 kHz, between approximately 50 kHz and approximately 60 kHz, between approximately 55 kHz and approximately 60 kHz, between approximately 55 kHz and approximately 65 kHz, between approximately 20 kHz and approximately 80 kHz, between approximately 25 kHz and approximately 80 kHz, between approximately 30 kHz and approximately 80 kHz, between approximately 35 kHz and approximately 80 kHz, between approximately 40 kHz and approximately 80 kHz, between approximately 45 kHz and approximately 80 kHz, between approximately 50 kHz and approximately 80 kHz, between approximately 55 kHz and approximately 80 kHz, between approximately 55 kHz and approximately 85 kHz, between approximately 60 kHz and approximately 80 kHz, between approximately 60 kHz and approximately 100 kHz, between approximately 80 kHz and approximately 100 kHz, between approximately 50 kHz and approximately 100 kHz, or the like). As used herein, “between” covers the specified range of frequencies including the specified minimum and maximum frequency defining the range. In some examples, the high frequency switching frequency is approximately 60 KHz.

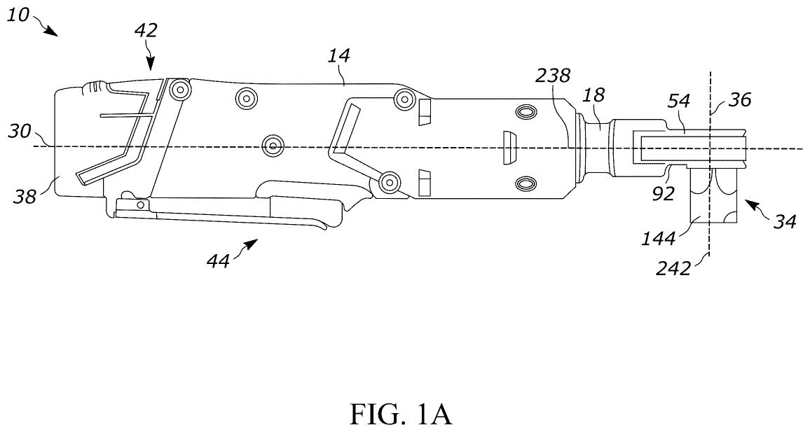

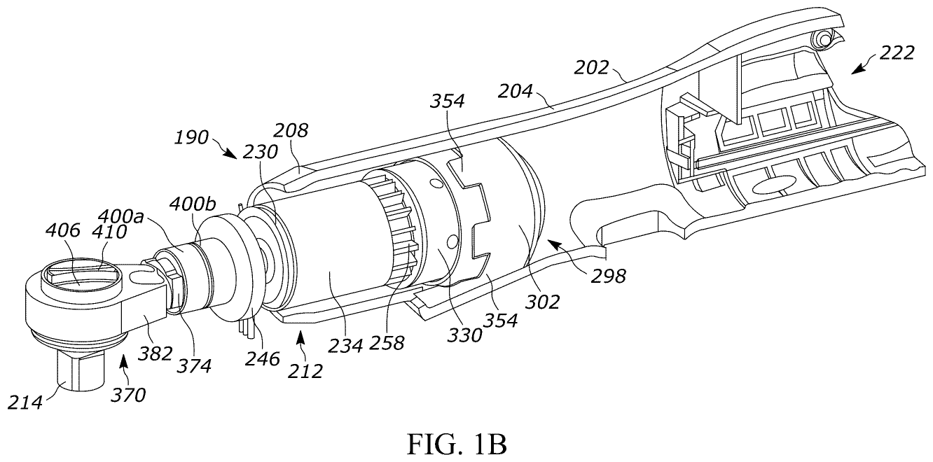

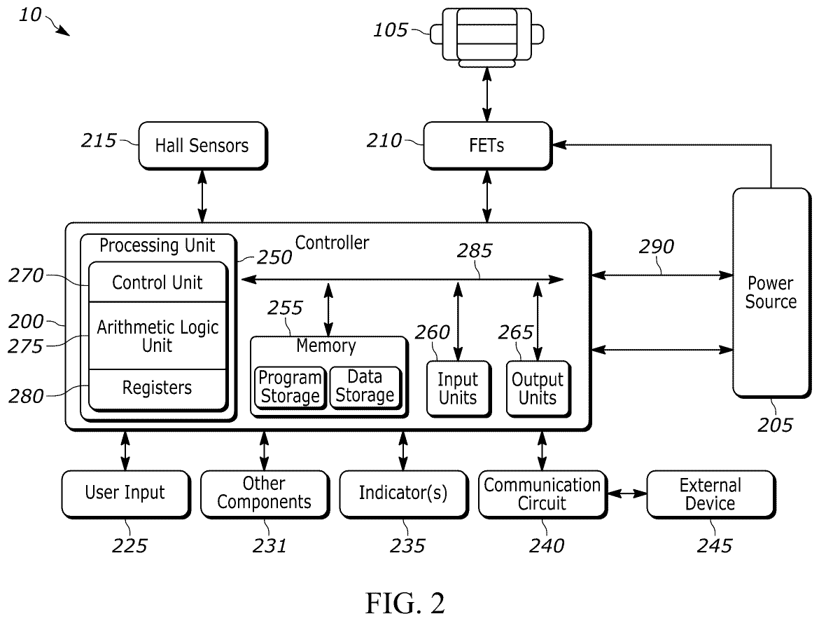

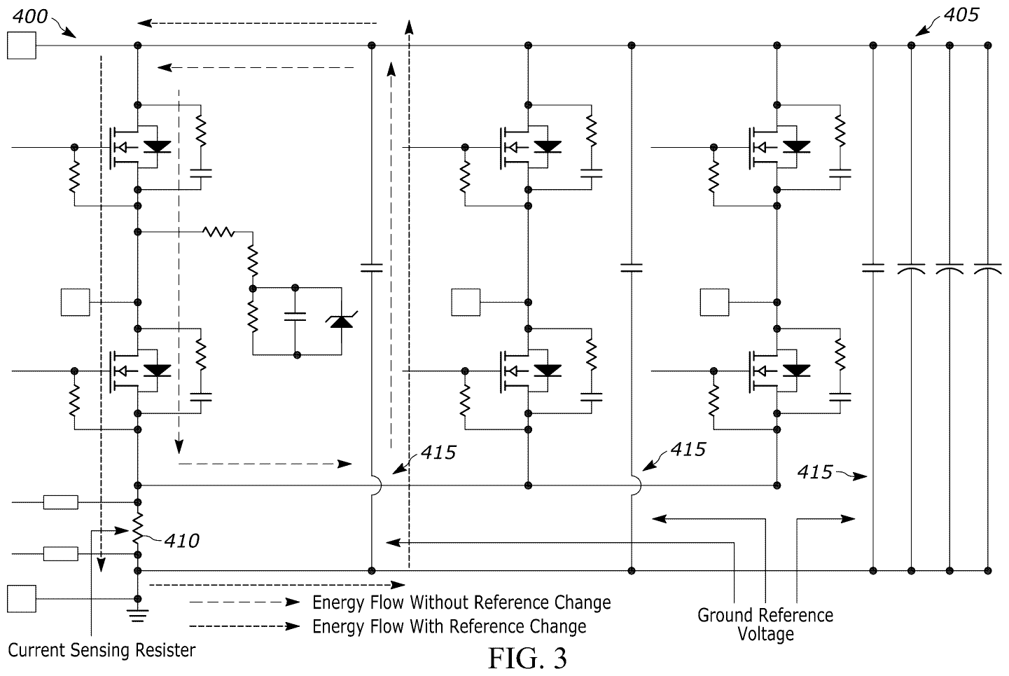

FIG. 1A illustrates a power tool 10 in accordance with aspects of the disclosure. As an example, the power tool 10 is a handheld powered ratchet tool that includes a housing 14 and a head 18 coupled to and extending from the housing 14. The powered ratchet tool 10 further includes a motor 105 (FIG. 2) supported within the housing 14. The motor 105 has an output shaft 26 rotatable about a first axis 30 to provide torque to an output drive 34 rotatably supported by the head 18 for rotation about a second axis 36 perpendicular to the first axis 30. In some examples, the motor 105 is an outer rotor motor (described below with respect to FIG. 3) having an outer diameter of approximately 28 millimeters (mm). In some examples, the motor 105 may be another type of motor and/or have an outer diameter of an alternative measurement. For instance, the motor 105 may be an outer rotor motor having an outer diameter between 20 mm and 40 mm, such as an outer diameter of 30 mm or 36 mm. It should be understood that although examples described herein relate to powered ratchet tools, the motor configuration and frequency switching control described herein can be used with various types of power tools and is not limited to powered ratchet tools. For example, the described outer rotor motor design may be used in various types of power tools needing a low clearance or an otherwise compact size and configuration.

In the illustrated example, the ratchet tool includes a power source 205 (see FIG. 2), such as, for example, a battery pack 38 received by a battery receptacle 42 formed in the housing 14 (e.g., opposite the head 18) (see FIG. 1A). The battery receptacle 42 electrically connects the battery pack 38 to the motor 105 (via suitable electrical and electronic components as illustrated in FIG. 2, such as a printed circuit board assembly (PCBA) containing one or more transistors (power semiconductor devices), such as, for example, one or more metal-oxide-semiconductor field-effect transistors (MOSFETs), one or more insulated-gate bipolar transistors (IGBTs), or the like). The illustrated embodiment includes field-effect transistors (FETs 210) arranged in an inverter bridge configuration, sometimes referred to as a half-bridge inverter or an inverter bridge.

Each bridge consists of two FETs 210 arranged in series between the positive and negative DC bus rails, with the midpoint forming one of the three output phases connected to the motor windings. In some examples, the FETs 210 are N-channel devices with low on-state resistance and fast switching characteristics. For example, wide-bandgap semiconductor materials such as silicon carbide (SiC) or gallium nitride (GaN) may be used to allow for the high switching frequency of the inverter bridge. The FETs are selected to handle the high current demands of the motor 105 while minimizing conduction and switching losses at high switching frequencies, such as the losses that occur while operating in high switching frequency range.

The battery pack 38 may be a 12-volt power tool battery pack that includes three lithium-ion battery cells. Alternatively, the battery pack 38 may include fewer or more battery cells to yield any of a number of different output voltages (e.g., 14.4 volts, 18 volts, etc.). Additionally, or alternatively, the battery cells may include chemistries other than lithium-ion such as, for example, nickel cadmium, nickel metal-hydride, or the like.

The ratchet tool 10 also includes an actuator 44 for controlling operation of the ratchet tool (e.g., to energize/de-energize the motor 105). In the illustrated embodiment, the actuator 44 is a push-button that can be depressed into the housing 14 to energize the motor 105. The illustrated actuator 44 extends from the housing 14 in the same direction as the output drive 34. In some instances, the power source 205 is a supply other than the battery pack 38, such as an alternating current (AC) power supply.

FIG. 1B illustrates an outer rotor motor used in a power tool 190, which is illustrated as a powered ratchet tool. A similar motor configuration may be used with the power tool 10. Similar to the power tool 10, the powered ratchet tool 190 includes a housing 202 having a handle housing 204 and a head 208 (i.e., yoke housing) coupled to the handle housing 204. The handle housing 204 serves as a handle configured to be grasped by a user during operation. The head 208 extends into the handle housing 204 such that a portion of the head 208 is surrounded by the handle housing 204. The ratchet tool further includes a motor 212 supported within the head 208, an output drive rotatably supported by the head 208, and a battery pack (not shown) received by a battery receptacle 222 formed in the handle housing 204 opposite the head 208. The battery receptacle 222 electrically connects the battery pack to the motor 212 (via suitable electrical and electronic components, such as a PCBA containing MOSFETs, IGBTs, or the like). The battery pack may be similar to the battery pack 38.

The motor 212 is a brushless DC (BLDC) electric motor. Specifically, the motor 212 is an outer rotor motor that includes an internal stator 230 and an outer rotor 234 that circumferentially surrounds at least a portion of the internal stator 230. The outer rotor 234 extends longitudinally along a first axis or motor axis 238, such that the internal stator 230 and the outer rotor 234 are coaxial about the motor axis 238. The outer rotor 234 rotates relative to the internal stator 230 about the motor axis 238 during operation of the ratchet tool. The motor 212 is configured to provide torque to the output drive to drive rotation of the output drive about a second axis or output axis 242 oriented perpendicular to the motor axis 238.

FIG. 2 illustrates an electromechanical diagram of the power tool 10 or 190, which includes a controller 200. The controller 200 is electrically and/or communicatively connected to a variety of modules or components of the power tool 10 or 190. For example, the illustrated controller 200 is connected to the power source 205 (e.g., previously described as the battery pack 38 in some implementations), one or more FETs 210, the motor 105 or 212, one or more Hall effect sensors 215 (also referred to as Hall sensors), a user input 225 (e.g., the actuator 44), one or more other components 231 (e.g., a battery pack fuel gauge, work lights [e.g., LEDs], current/voltage sensors, etc.), one or more indicators 235 (e.g., LEDs), and a communication circuit 240 (e.g., a transceiver or a wired interface) configured to communicate with an external device 245 (e.g., a smartphone, a tablet computer, a laptop computer, and the like), or a combination thereof. As previously described, the FETs 210 may include metal-oxide-semiconductor field-effect transistors (e.g., MOSFETs). In some examples, the FETs 210 include wide bandgap semiconductor FETs, which may include Gallium Nitride (GaN) and/or Silicon Carbide (SiC) based FETs. In yet another example, the FETs 210 may include a combination of MOSFETs and wide bandgap semiconductor FETs.

The controller 200 includes combinations of hardware and software operable to, among other things, control the operation of the power tool 10, control power provided to the motor 105, etc. In some embodiments, the controller 200 includes a plurality of electrical and electronic components that provide power, operational control, and protection to the components and modules within the controller 200 and/or power tool 10. For example, the controller 200 includes, among other things, a processing unit 250 (e.g., a microprocessor, a microcontroller, or another suitable programmable device) having a timer configured for pulse-width modification mode and a clock frequency allowing current sampling and averaging during high frequency switching events (e.g., a clock capable of generating a high frequency inverter switching signal as defined herein), a memory 255, input units 260, and output units 265. The processing unit 250 includes, among other things, a control unit 270, an arithmetic logic unit (“ALU”) 275, and a plurality of registers 280 (shown as a group of registers in FIG. 2) and is implemented using a known computer architecture (e.g., a modified Harvard architecture, a von Neumann architecture, etc.). The processing unit 250, the memory 255, the input units 260, and the output units 265, as well as the various modules connected to the controller 200 are connected by one or more control and/or data buses (e.g., a common bus 285). The control and/or data buses are shown generally in FIG. 2 for illustrative purposes. The use of one or more control and/or data buses for the interconnection between and communication among the various modules and components would be known to a person skilled in the art in view of the invention described herein.

The memory 255 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 250 is connected to the memory 255 and executes software instructions that are capable of being stored in a RAM of the memory 255 (e.g., during execution), a ROM of the memory 255 (e.g., on a generally permanent basis), or another non-transitory computer readable medium such as another memory or a disc. Software included in the implementation of the power tool 10 or 190 can be stored in the memory 255 of the controller 200. The software includes, for example, firmware, one or more applications, program data, filters, rules, one or more program modules, and other executable instructions. The controller 200 is configured to retrieve from memory and execute, among other things, instructions to perform the motor and tool control described herein. In other constructions, the controller 200 includes additional, fewer, or different components.

The power source 205 provides DC power to the various components of the power tool 10. As previously described, the power source 205 may be a battery pack 38. In other embodiments, the power source 205 may receive AC power (e.g., 120V/60 Hz) from a tool plug that is coupled to a standard wall outlet, and then filter, condition, and rectify the received power to output DC power. In some embodiments, the power tool 10 or 190 includes, for example, a communication line 290 for providing a communication line or link between the controller 200 and the power source 205.

Each of the Hall sensors 215 outputs motor feedback information, such as an indication (e.g., a signal or a pulse) related to when a magnet of the rotor of the motor 105 or 212 rotates across the face of that Hall sensor 215. Based on the motor feedback information from the Hall sensors 215, the controller 200 is configured to determine the rotational position, speed, and/or acceleration of the rotor.

The power tool 10 or 190 may be configured to operate in various modes. For example, the controller 200 may be configured to receive one or more user commands or controls from the user input 225, such as a selected operating mode input via a mode select button, a selected ratchet direction input via a forward/reverse selector, or an energize or de-energize input received via the actuator 44. In response to the motor feedback information and user controls, the controller 200 generates control signals to control the FETs 210 to drive the motor 105 or 212. The control signals may be generated in response to motor feedback information from Hall sensors 215 and user controls from the user input 225, such as an actuator 44. The control signals operate the FETs 210, and by selectively enabling and disabling the FETs 210, power from the power source 205 is applied to stator coils of the motor 105 or 212 to cause rotation of the rotor of the motor 105 or 212. The control signal may generally be considered a pulse-width modulation (PWM) signal that enables or disables select FETs 210.

The speed at which the FETs 210 are controlled is generally referred to as a switching speed. This may also be referred to as a switching frequency. In other words, the frequency (i.e., the number of complete periods that occur in 1 second, measured in Hertz (Hz)) of the control signal (e.g., the PWM signal indicating which of the FETs 210 to selectively turn on and/or off) is selected (i.e., set) by the controller 200. The control signal is then generated (e.g., by the controller 200), at the selected switching frequency, to drive the FETs 210 at the selected switching speed. Traditional switching speeds may include approximately 8 kHz. As previously described, the switching speeds of the FETs 210 described herein are between approximately 20 kHz and approximately 100 kHz or a subrange thereof (see definition above). For example, in some implementations, the FETs 210 are driven via the generated control signal at a switching speed of approximately 60 KHz.

High frequency switching involves rapidly turning the FETs 210 on and off at a rapid rate that is significantly higher than traditional inverter designs. By switching at high frequencies, the inverter can adjust the power delivery to the motor 105 with precision, allowing for finer control of motor speed, torque, and overall performance as compared to lower switching frequencies. High frequency switching also allows for smoother motor operation, which reduces torque ripple, minimizes audible noise from the motor, and results in a more comfortable user experience.

In some examples, the power tool 10 or 190 includes additional aspects to improve motor and overall tool performance. For example, with the high frequency switching described above (or separate therefrom), the power tool 10 or 190 may implement one or more of the following configurations (e.g., (1) modified capacitor reference point, (2) synchronous rectification, and (3) hybrid polymer capacitors) to improve motor and overall tool performance and, in particular, reduce current ripple and associated thermal losses associated with low inductance motor, such as, for example, outer rotor motor configurations.

For example, the capacitors in the inverter bridge may be surface mounted, which may cause instability in current measurements taken by the controller 200 (e.g., current ripple). To address this instability, the capacitor's voltage reference point may be changed to be outside of the loop measured by a current sensor (e.g., a current sense resistor) to reduce the impact of this instability on the measurement and improve accuracy, such as, for example, when using high switching frequency. In other words, the reference voltage point of the current sense resistor is changed to be different than the reference voltage point of the bridge capacitors. For example, FIG. 3 is a circuit diagram current measurement circuitry 400 included in the power tool 10 or 190. The circuitry 400 includes bridge capacitors (caps) 405 configured to stabilize the voltage supplied by the power source 205, or battery pack 38, to the FETs 210. The bridge capacitors 405 provide a low-impedance source of current for the rapid switching as the FETs 210 drive the motor 105 or 212. The circuitry 400 also includes a current sense resistor 410 and ground reference voltage points 415. The current sense resistor 410 measures the current across the bridge capacitors 405 and provides a current signal to the controller 200. Traditionally, the reference point for the current sense resistor 410 is within the same electrical loop (e.g., the source of the current provided by the power source 205) as the bridge capacitors 405. However, when operating at high frequencies, this may introduce current measurement instability.

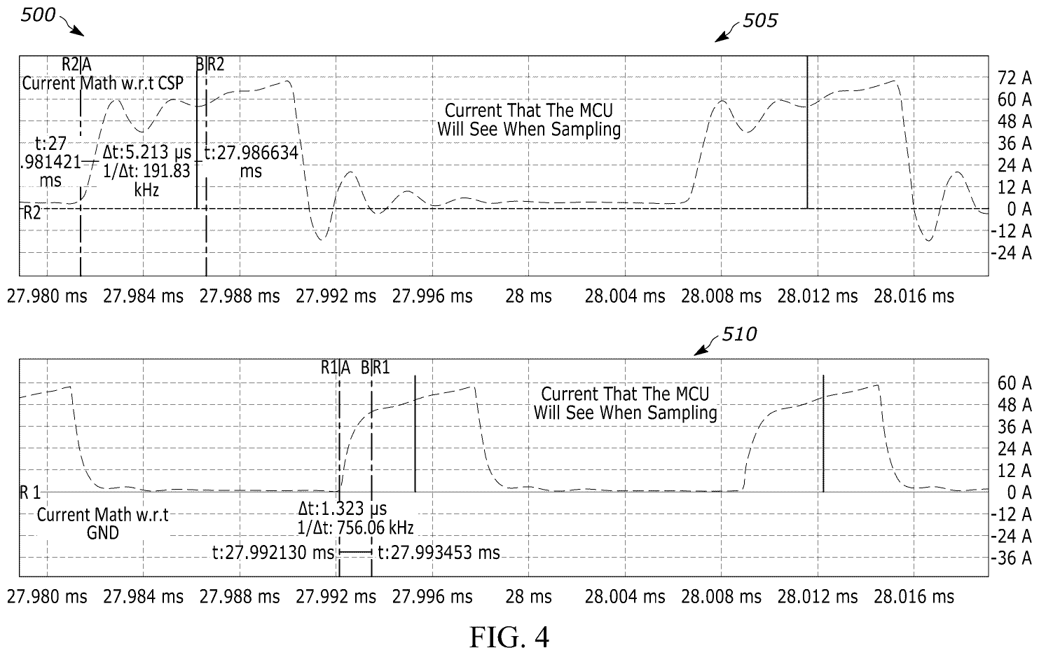

By changing the ground reference voltage points 415 such that the capacitor's reference points are outside the loop when measured by the current sense resistor, the bridge capacitors' 405 impact on the current measurement is lessened, which improves the accuracy of the measurement (e.g., as input to and processed by the controller 200). For example, FIG. 4 is a graphical illustration of current ripple across the bridge capacitors 405 as measured by the current sense resistor 410. The graph 500 includes a first current measurement 505 that traces the current across the current sense resistor 410 in the traditional configuration. As illustrated, unwanted current ripple occurs when the controller 200 samples the current across the current sense resistor 410. The second current measurement 510 demonstrates the measured current across the current sense resistor 410 when the ground reference voltage points 415 are modified as described above with respect to FIG. 3. As shown, the current ripple of the second current measurement 510 is significantly reduced when compared to the current ripple of the first current measurement 505.

In some examples, synchronous rectification (“sync rect”) may also be used to reduce thermal losses, such as through non-switching transistors (MOSFETs). Such synchronous rectification may also improve the relationship between applied power and output speed. For example, a low inductance motor may experience more rapid current changes as compared to a traditional motor configuration. For example, a low inductance outer rotor motor may reach approximately 90% of a maximum speed at approximately 60% of applied power and increasing switching frequency may further affect this speed linearity of the motor. Using synchronous rectification in such a low inductance outer rotor motor, however, may make this relationship more linear.

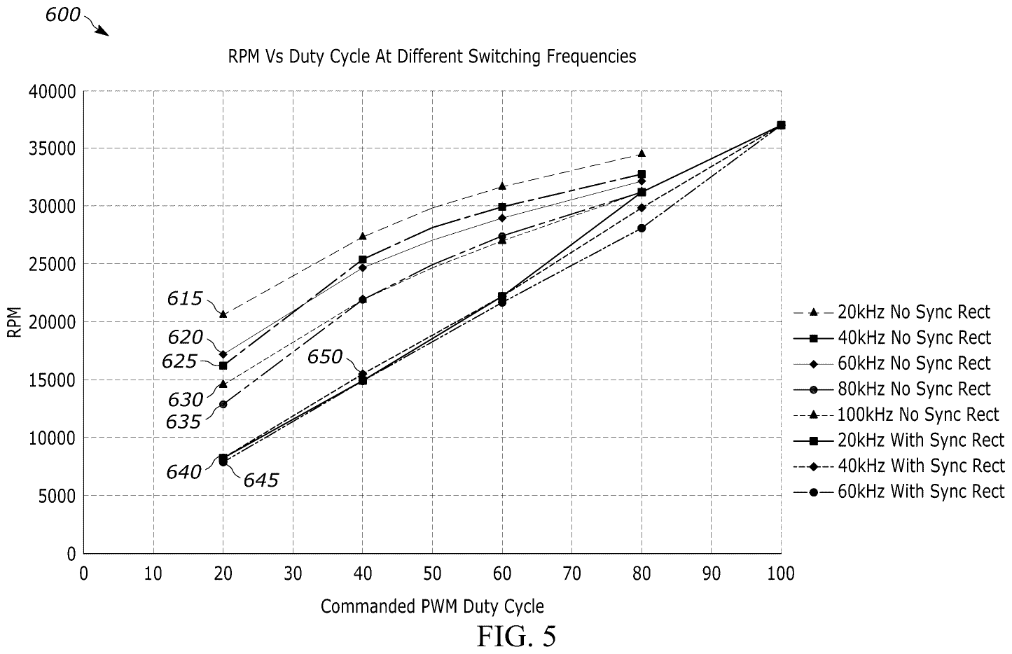

For example, FIG. 5 is a graph of inverter switching frequencies according to some aspects. As previously described, maintaining thermal losses may be important for low inductance motors, such as outer rotor motor configurations. To account for these thermal losses, the controller 200 may use synchronous rectification to reduce the thermal losses of the FETs 210 (e.g., the non-switching FETs 210). By using synchronous rectification, the controller 200 may improve efficiency and performance of the motor. As demonstrated, the switching frequencies without synchronous rectification are non-linear and motor revolutions per minute (RPM) is reduced relative to the pulse width modulation (PWM) duty cycle as commanded by the controller 200. For example, the graph 600 includes trace 615, which is a 20 kHz switching frequency without synchronous rectification. The graph 600 also includes trace 620, which is a 40 kHz switching frequency without synchronous rectification. The graph 600 includes trace 625, which is a 60 kHz switching frequency without synchronous rectification. The graph 600 includes trace 630, which is an 80 kHz switching frequency without synchronous rectification. The graph 600 includes trace 635, which is a 100 kHz switching frequency without synchronous rectification.

However, with synchronous rectification applied, the RPM increases linearly with the PWM duty cycle. For example, the graph 600 includes trace 640, which is a 20 kHz switching frequency with synchronous rectification. The graph 600 also includes trace 645, which is a 40 kHz switching frequency with synchronous rectification. The graph 600 includes trace 650, which is a 60 kHz switching frequency with synchronous rectification. The use of synchronous rectification further lowers the thermal losses through the FETs 210 by converting the thermal losses that occur through the FET body diode into conduction losses that dissipate heat through a different part of the FET body. This allows for the more linear relationship between the RPM and the PWM duty cycle and improves overall efficiency.

As noted above, low inductance systems (such as outer rotor motor configurations) may experience high current ripple, which can create thermal management issues. Accordingly, in some examples, one or more capacitors (e.g., three capacitors) in the power tool include hybrid polymer capacitors, which have lower equivalent series resistance (ESR) than other types of capacitors (e.g., aluminum electrolytic capacitors) of the same capacitance. A lower resistance means that the hybrid polymer capacitors experience lower thermal losses than other types of capacitors (e.g., aluminum electrolytic counterparts), which dissipate less heat due to their lower ESR and thus provide more reasonable thermal characteristics. In addition, hybrid polymer capacitors generally have high maximum thermal allowance before degradation. In some examples, one or more of the bridge capacitors 405 as described above are hybrid polymer capacitors.

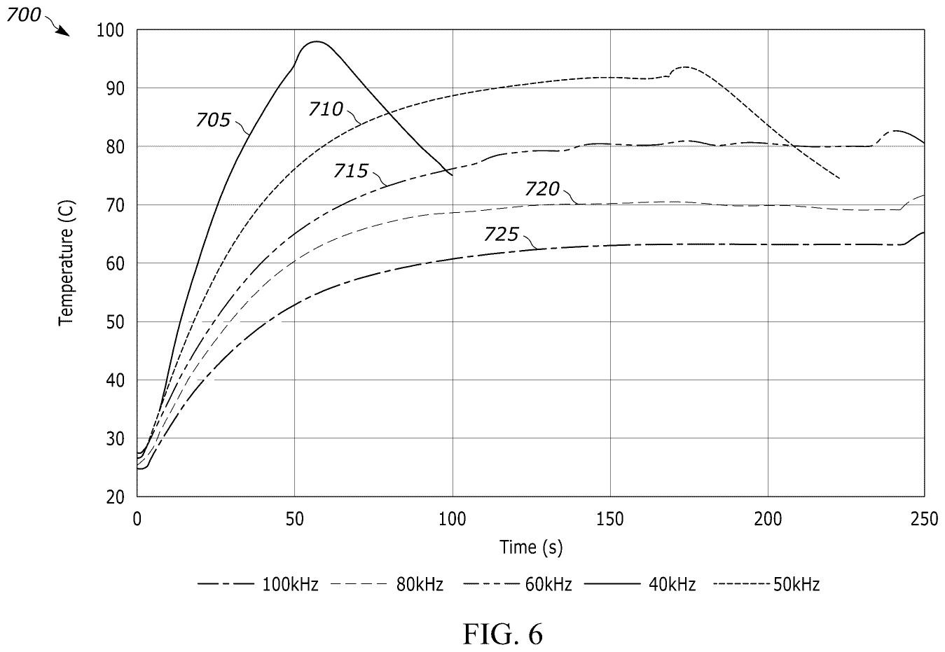

For example, FIG. 6 is a graph of capacitor (e.g., bridge capacitor) temperatures at differing switching frequencies, according to some aspects and shows that, as the switching frequency changes from 50 kHz to 100 kHz, there is an overall decrease in the rate of thermal climb. The graph 700 includes trace 705, which is a capacitor 405 temperature over time when switching at a frequency of 40 kHz. The graph 700 includes trace 710, which is a capacitor 405 temperature over time when switching at a frequency of 50 kHz. The graph 700 includes trace 715, which is a capacitor 405 temperature over time when switching at a frequency of 60 KHz. The graph 700 includes trace 720, which is a capacitor 405 temperature over time when switching at a frequency of 80 kHz. The graph 700 includes trace 725, which is a capacitor 405 temperature over time when switching at a frequency of 100 kHz. As demonstrated on the graph 700, the temperature of the capacitors 405 is generally lower over time as the switching frequency increases. For example, the temperature of the capacitors 405 operating at 60 kHz at 150 seconds is approximately the same as the temperature of the capacitors 405 at 200 seconds and at 250 seconds.

As noted above, thermal losses can also be managed by the type of capacitors used in the tool. Traditionally, some capacitors used in power tool are a standard aluminum electrolytic. However, as noted above, hybrid polymer capacitors have a lower equivalent series resistance (ESR) than aluminum electrolytic capacitors, and therefore provide lower thermal losses at the same capacitance levels. Due to the lower ESR, the hybrid polymer capacitors dissipate less heat during high frequency switching, resulting a steady thermal profile. Additionally, hybrid polymer capacitors have a higher thermal characteristic which operate well with high switching frequencies (e.g., up to approximately 100 kHz) that the aluminum electrolytic capacitors struggle to support.

Although the disclosure has been described in detail with reference to certain preferred embodiments, variations and modifications exist within the scope and spirit of one or more independent aspects of the disclosure as described.

What is claimed is:

1. An electric ratchet power tool comprising:
a housing;
a battery pack receptacle coupled to the housing and configured to receive a power tool battery pack;
a motor supported within the housing, the motor configured to be powered by the power tool battery pack;
an inverter electrically connected to the motor, the inverter including a plurality of switching elements; and
a controller including an electronic processor configured to generate a control signal to operate the plurality of switching elements of the inverter at a switching frequency between approximately 20 kilohertz and approximately 100 kilohertz to provide power from the power tool battery pack to drive the motor.

2. The power tool of claim 1, wherein the motor is an outer rotor motor.

3. The power tool of claim 2, wherein the motor has an outer diameter between 20 millimeters and 40 millimeters.

4. The power tool of claim 2, wherein the motor has an outer diameter of 28 millimeters.

5. The power tool of claim 1, wherein the switching frequency is approximately 60 kilohertz.

6. The power tool of claim 1, wherein the switching frequency is approximately 80 kilohertz.

7. The power tool of claim 1, wherein the switching frequency is approximately 100 kilohertz.

8. The power tool of claim 1, wherein the controller is configured to generate a control signal to operate the plurality of switching elements of the inverter at a switching frequency of approximately 60 kilohertz, wherein the control signal is generated using synchronous rectification.

9. The power tool of claim 1 further comprising:
a current sense resistor configured to sense an electrical current of the plurality of switching elements, the current sense resistor having a first reference voltage point, and
a plurality of bridge capacitors electrically connected to the plurality of switching elements, the plurality of bridge capacitors having a second reference voltage point,
wherein the first reference voltage point is different than the second reference voltage point.

10. The power tool of claim 9, wherein the plurality of bridge capacitors includes at least one hybrid polymer capacitor.

11. A controller for a handheld power tool, the controller comprising:
a memory storing instructions;
a processing unit communicatively coupled to the memory and configured to execute the instructions to perform a set of functions, the set of functions comprising:
generating a control signal for an inverter included in the handheld power tool, the inverter having a plurality of switching elements, the control signal operating the plurality of switching elements at a switching frequency between approximately 20 kilohertz and approximately 100 kilohertz to drive an outer rotor motor included in the handheld power tool.

12. The controller of claim 11, wherein the controller is configured to generate a control signal to operate the plurality of switching elements of the inverter at a switching frequency of approximately 60 kilohertz, wherein the control signal is generated using synchronous rectification.

13. The controller of claim 11, wherein generating the control signal includes:
receiving a reference voltage of a current sense resistor, the current sense resistor electrically coupled to the plurality of switching elements, and
generating the control signal based upon the reference voltage of the current sense resistor,
wherein the reference voltage of the current sense resistor is different than a reference voltage of a bridge capacitor electrically connected to the plurality of switching elements.

14. The controller of claim 11, wherein the switching frequency is approximately 60 kilohertz.

15. The controller of claim 11, wherein the switching frequency is approximately 80 kilohertz.

16. The controller of claim 11, wherein the switching frequency is approximately 100 kilohertz.

17. A power tool comprising:
a housing;
an outer rotor motor supported within the housing, the outer rotor motor having a diameter between approximately 20 millimeters and 40 millimeters;
an inverter electrically connected to the motor, the inverter including a plurality of switching elements; and
a controller including an electronic processor configured to generate a control signal to operate the plurality of switching elements of the inverter at a switching frequency between approximately 20 kilohertz and approximately 100 kilohertz to drive the outer rotor motor.

18. The power tool of claim 17, wherein the outer rotor motor has a diameter between approximately 30 millimeters and 36 millimeters.

19. The power tool of claim 17, wherein the controller is configured to generate a control signal to operate the plurality of switching elements of the inverter at a switching frequency of approximately 60 kilohertz, wherein the control signal is generated using synchronous rectification.

20. The power tool of claim 17, wherein the plurality of switching elements include at least one gallium nitride N-channel switch.
